(19) United States
(12) Patent Application Publication
(10) Pub. No.: US 2018/0098015 A1
(43) Pub. Date: Apr. 5, 2018

(54) METHOD AND APPARATUS FOR EMBODYING ADC AND PGA USING COMMON AMPLIFIER

(71) Applicant: Center for Integrated Smart Sensors Foundation, Daejeon (KR)

(72) Inventors: Sang Jin Lee, Daejeon (KR); Jong Ho Park, Daejeon (KR)

(21) Appl. No.: 15/566,509

(22) PCT Filed: Apr. 14, 2015
(86) PCT No.: PCT/KR2015/003732

§ 371 Date: Oct. 13, 2017

(51) Int. Cl. H04N 5/3745; H04N 5/378

(52) U.S. Cl. CPC H04N 5/37455; H04N 5/378

(57) ABSTRACT

Provided are a method and an apparatus for embodying an ADC and a PGA using a common amplifier. The apparatus for embodying ADC and PGA using a common amplifier according to the present invention may comprise: a switching unit for performing a phase shift according to a switching operation; a detection unit for detecting a pixel output in a first phase according to control of the switching unit; and an amplification and conversion unit for amplifying the pixel output detected in a second phase according to the control of the switching unit, and for performing an analog-digital conversion in a fourth phase according to the control of the switching unit.

### TECHNICAL FIELD

The present disclosure relates to a method and apparatus for embodying an analog to digital converter (ADC) and a programmable gain amplifier (PGA) using a common amplifier.

### BACKGROUND

A pixel of an image sensor for obtaining a color image may be implemented in the form of an array in which a color filter is combined to an upper portion of a light sensing portion for receiving light from the outside and generating and accumulating photocharges (e.g., a device for generating photo-current in proportion to an amount of light incident to a photo-detector).

In general, a color filter array (CFA) may be implemented with three colors of red, green, and blue or may be implemented with three colors of yellow, magenta, and cyan. A core function of an image sensor may be performed by a pixel array and column circuits. A column circuit of a general image sensor may be implemented with an amplifier for amplifying a small electric signal of a pixel and an ADC for converting an analog signal into a digital signal. A description will be given of a color circuit portion of a conventional image sensor with reference to FIGS. 1 and 2.

FIG. 1 is a drawing illustrating a configuration of an image sensor according to the related art. Referring to FIG. 1, a conventional image sensor may include a programmable gain amplifier (PGA) for amplifying each pixel value by a red, gain, blue (RGB) color pixel array depending on each gain and offset correction value, an ADC for converting analog data amplified by the PGA into digital data, and a multiplexer for integrating the digital data received from the ADC to output image output data. An embodiment is exemplified as the multiplexer is for a conceptual description for a read-out operation of an image sensor. Embodiments are not limited thereto.

FIG. 2 is a drawing illustrating a configuration of a conventional image sensor according to another embodiment. An image sensor in FIG. 2 has a column-parallel structure in which all columns of a pixel array respectively have column circuits. For example, although not described, a color pixel may be configured with R, Gr, Gb, and B in the conventional image sensor. In general, such four unit pixels may be implemented as two columns. Thus, in case of the column-parallel structure, two column circuits may be used for four pixels. The conventional image sensor may be configured with a single column circuit or a plurality of column circuits. Thus, since the conventional image sensor should correct a gain value and an offset for each PGA and since each PGA varies in linearity, a problem may occur in an operation of auto white balance (AWB) or the like. Further, a logic circuit portion may be increased in area due to a plurality of PGAs, and there is much power consumption. There is a need for a multiplexer circuit for integrating data output by each PGA and each ADC.

### SUMMARY

### Technical Problem

An aspect of the present disclosure is to provide a method and apparatus for reducing power consumption and a size of a circuit by mixing an ADC with a PGA of a complementary metal-oxide semiconductor (CMOS) image sensor (embodying the ADC and the PGA using a common amplifier).

### Technical Solution

In accordance with an aspect of the present disclosure, an apparatus for embodying an analog to digital converter (ADC) and a programmable gain amplifier (PGA) using a common amplifier is provided. The apparatus may include a switching unit configured to perform a phase shift according to a switching operation, a capacitor unit configured to include an input capacitor for playing a role as sample and hold (S/H) of a pixel signal and correlated double sampling (CDS) depending on control of the switching unit and a feedback capacitor for adjusting an amplification ratio, and an operational amplifier configured to perform analog-to-digital (AD) conversion by playing a role as an amplifier and a comparator depending on control of the switching unit.

The operational amplifier may include one amplifier and may perform amplification and AD conversion of a pixel output using the one amplifier depending on control of the switching unit.

The operational amplifier may amplify a signal by the amplification ratio using a switched-capacitor (SC) amplifier and may fail to amplify a noise of a high frequency component (e.g., a thermal noise).

In accordance with another aspect of the present disclosure, a method for embodying an ADC and a PGA using a common amplifier is provided. The method may include detecting, by a detection unit of a complementary metal-oxide semiconductor (CMOS) image sensor, a pixel output depending on control of a switching unit, amplifying, by an amplification and conversion unit of the CMOS image sensor, the detected pixel output depending on control of the switching unit, storing, by the amplification and conversion unit, the amplified pixel output in a capacitor, and performing, by the amplification and conversion unit, AD conversion depending on control of the switching unit.

The amplifying of the detected pixel output in a second phase depending on the control of the switching unit and the performing of the AD conversion in a fourth phase depending on the control of the switching unit may include performing the amplification and AD conversion of the pixel output using one amplifier depending on the control of the switching unit.

The amplification of the detected pixel output in a second phase depending on the control of the switching unit may include amplifying the detected pixel output in the second phase using an analog amplifier.

The amplification of the detected pixel output in a second phase depending on the control of the switching unit may include increasing a signal of the pixel output and a low frequency noise by an amplification ratio and may fail to amplify a high frequency noise by amplifying the detected pixel output in the second phase using an analog amplifier.

Embodiments of the present disclosure may reduce power consumption and a size of a circuit by being applied to a PGA and a single slope ADC using one amplifier.

### BRIEF DESCRIPTION OF DRAWINGS

FIG. 1 is a drawing illustrating a configuration of an image sensor according to the related art;

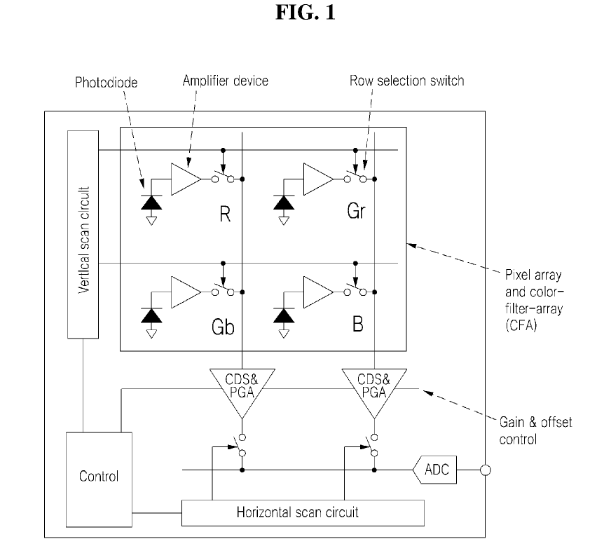

FIG. 2 is a drawing illustrating a configuration of another image sensor according to the related art according to an embodiment of the present disclosure;

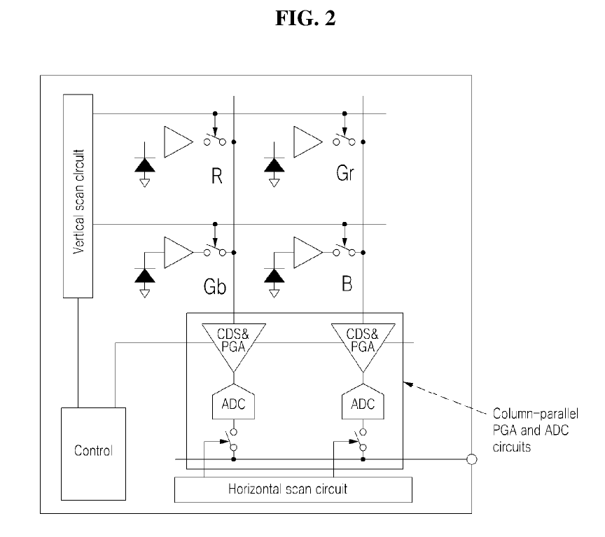

FIG. 3 is a circuit diagram illustrating a CMOS image sensor according to the related art according to an embodiment of the present disclosure;

FIG. 4 is a circuit diagram illustrating an apparatus for embodying an ADC and a PGA using a common amplifier according to an embodiment of the present disclosure;

FIGS. 5A, 5B, 5C, 5D, 5E, and 5F are equivalent circuit diagrams and a timing diagram illustrating an operation of an apparatus for embodying an ADC and a PGA using a common amplifier according to an embodiment of the present disclosure;

FIG. 6 is a drawing illustrating a change in an output of an image sensor according to a change in a pixel output according to an embodiment of the present disclosure; and

FIG. 7 is a flowchart illustrating a method for embodying an ADC and a PGA using a common amplifier according to an embodiment of the present disclosure.

### DETAILED DESCRIPTION

Hereinafter, a description will be given in detail of embodiments of the present disclosure with reference to the accompanying drawings.

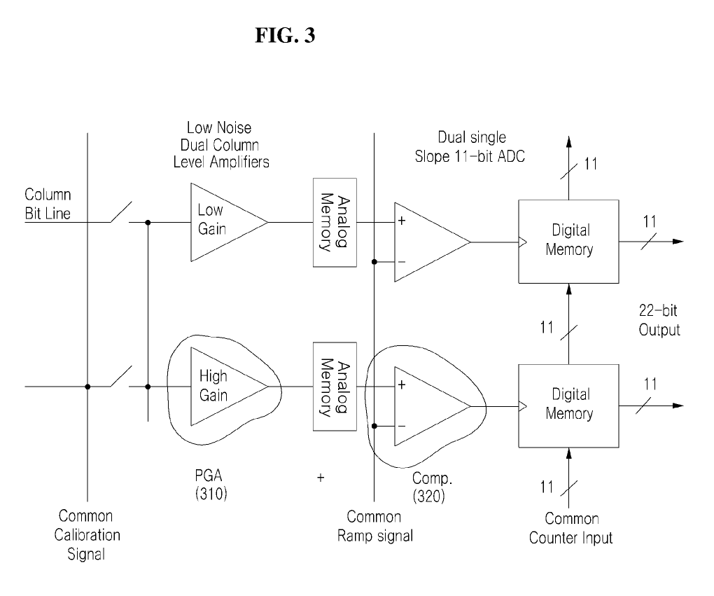

FIG. 3 is a circuit diagram illustrating a CMOS image sensor according to the related art according to an embodiment of the present disclosure.

FIG. 3 illustrates a structure of a product commercialized by separately embodying a PGA and an ADC. Referring to FIG. 3, since a column circuit is increased in size by separately embodying an operational amplifier in a PGA and an ADC, it is difficult to universally apply general image sensors. However, if a proposed structure is used, a size may be reduced and there is an advantage in terms of power.

According to the related art, the principle of a CMOS image sensor is devised in the late 1960s, but is put to practical use in the late 1990s when microfabrication technology is more advanced. As high-resolution of image sensor technology is advanced since the late 2000s, back side illumination (BSI) process technology and three-dimensional (3D) stacking sensor fabrication process technology come to the fore.

Contrary to simultaneously proceeding with processes of an optical integrated portion and a driving circuit portion of pixels on one wafer, a process of fabricating a 3D CMOS image sensor (CIS) through wafer stacking may be accomplished in a manner of proceeding with a process of each of the optical integrated portion and the driving circuit portion on a different wafer, bonding two wafers after a constant process, and proceeding with a subsequent constant process. In other words, a process may efficiently progress for only the optical integrated portion on one wafer, and a process may efficiently progress for only the driving circuit portion, which receives and processes a signal of the optical integrated portion and outputs an output signal, on the other wafer. In this case, bonding pads for bonding the two wafers may be formed on the two wafers, respectively, and the bonding pads are stacked up and down to be in contact with each other.

The CMOS image sensor according to the related art may include amplifiers 310 and 320 per unit cell. In the CMOS image sensor, an electrical noise may be reduced by reading of an optically converted electric signal. Since mass production is possible due to application of a CMOS logic large scale integrated circuit (LSI) fabrication processor, as compared with a charge coupled device CCD image sensor having a high-voltage analog circuit, unit cost of manufacture may be low and a device may be small in size to have low power consumption.

A logic circuit is manufactured by the same process, and an image processing circuit may be implemented with an on-chip to be applied to an image recognition device or an artificial vision device. Part of the image processing circuit may be commercialized. The image processing circuit may be called an artificial retina chip.

As compared with a CCD, there are several advantages. However, there is a tendency that a device is easily unstable in a low illumination situation and that many noises occur in a captured image. There are disadvantages in terms of power consumption and size by separately using the amplifier 310 for amplifying a pixel output and the amplifier 320 for performing analog-to-digital (AD) conversion. Further, since a fixed amplifier is assigned per pixel, there is a fixed pattern noise by a characteristic difference of the amplifier. There is a need for correcting the fixed pattern noise. Recently, a signal to noise ratio may be considerably enhanced by several improvement means, such as high power of a personal computer (PC), a low noise of the PC, enhancement of efficiency of charge transmission from a photodiode (PD) to an amplifier, and sharing of a plurality of pixels of a transistor for relatively enlarging a light receiving size of the PD.

An image may be shaken to a progress direction when capturing an object moved at a high speed, due to a structural problem which may fail to simultaneously execute charging. This may be overcome by blocking one CMOS. Herein, since an advantage of a CMOS with a low price is offset due to this technical approach, the CMOS is used less in a small digital camera. Meanwhile, if an imaging device, such as a digital single lens reflex (DSLR) camera, is large in size, a CCD has a disadvantage in terms of power consumption.

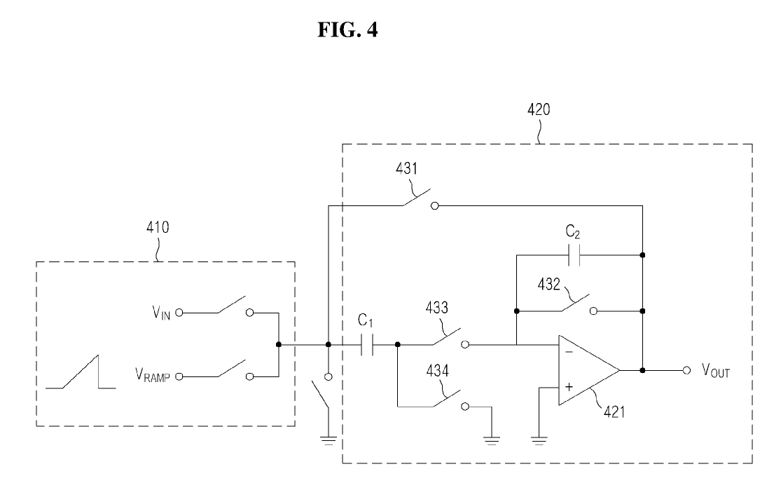

FIG. 4 is a circuit diagram illustrating an apparatus for embodying an ADC and a PGA using a common amplifier according to an embodiment of the present disclosure.

The apparatus for embodying the ADC and the PGA using the common amplifier may include a switching unit, a capacitor unit, and an operational amplifier 421.

The switching unit may include a plurality of switches 431 to 434 for performing a phase shift according to a switching operation of a proposed CMOS image sensor.

The capacitor unit may include an input capacitor C1 for playing a role as sample and hold (S/H) and correlated double sampling (CDS) of a pixel signal according to control of the switching unit and a feedback capacitor C2 for adjusting an amplification ratio. In this case, a noise signal may be included in a pixel output. A bandwidth of the noise signal may be limited in the pixel output received for effective image sensing, and a level of the pixel output should be amplified.

The operational amplifier 421 may perform analog-to-digital (AD) conversion by playing a role of an amplifier and a comparator depending on control of the switching unit. The operational amplifier 421 may perform AD conversion depending on control of the switching unit. The operational amplifier 421 may include one amplifier and may perform amplification and AD conversion of the pixel output using the one amplifier depending on control of the switching unit.

The operational amplifier 421 may include one amplifier and may perform amplification and AD conversion of the pixel output using the one amplifier depending on control of the switching unit. Further, the operational amplifier 421 may amplify a detected pixel output using an analog amplifier. The operational amplifier 421 may amplify a signal by an amplification ratio using a switched-capacitor (SC) amplifier and may fail to amplify a noise (e.g., a thermal noise) of a high frequency component. Herein, a change VR-VS in pixel output voltage may be amplified by an amplification ratio.

In other words, the SC amplifier may perform amplification using a characteristic such as a low-pass filter (LPF). As an amplification ratio is set to be higher, a band limit frequency may be lowered. Thus, a noise may be reduced throughout a wider frequency band.

Since the circuit shown in FIG. 4 is needed per pixel, it may greatly reduce power consumption and may considerably reduce a circuit area by performing amplification and AD conversion of the pixel output using the one operational amplifier 421.

The circuit may amplify the detected pixel output in a second phase using an analog amplifier. In this case, a bandwidth of a noise may be limited and a level of the noise may fail to be amplified by amplifying the detected pixel output in the second phase using the analog amplifier.

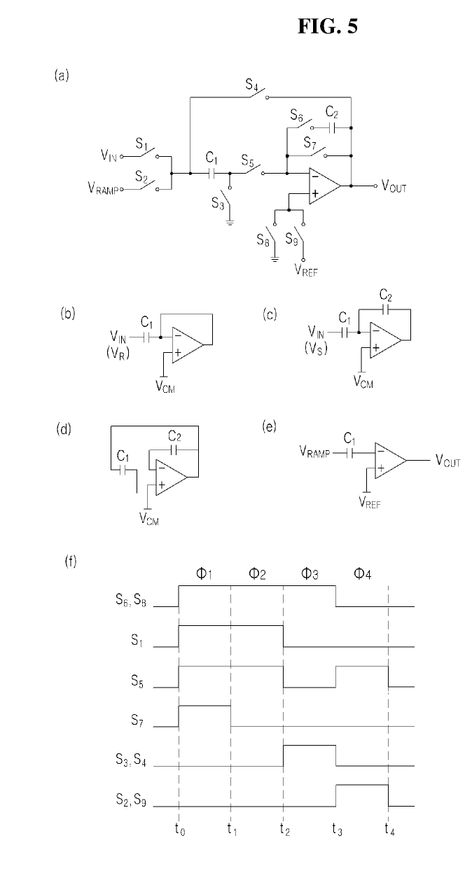

FIGS. 5A to 5F are equivalent circuit diagrams and a timing diagram illustrating an operation of an apparatus for embodying an ADC and a PGA using a common amplifier according to an embodiment of the present disclosure.

FIG. 5A is a drawing illustrating a circuit for embodying an ADC and a PGA of a CMOS image sensor including a switching unit, a capacitor unit, and an operational amplifier 421 using a common amplifier.

FIGS. 5B to 5E illustrate equivalent circuits in respective phases according to control of a switching unit.

FIG. 5F illustrates a timing diagram of a plurality of switches in each phase according to an embodiment.

As shown in FIG. 5A, a circuit for embodying an ADC and a PGA of a CMOS image sensor using a common amplifier may include a plurality of switches S1 to S9 and one operational amplifier. The proposed circuit may perform a phase shift depending on control of the plurality of switches S1 to S9 and may perform an operation of detecting and amplifying a pixel output and performing AD conversion depending on each phase shift.

FIGS. 5B and 5C illustrate a first phase φ₁ and a second phase φ₂ depending on control of a switching unit. A voltage V_{R} when a pixel is reset for CDS in the first phase φ₁ and the second phase φ₂ may be stored in a capacitor C1. As shown in an equivalent circuit shown in FIG. 5B, both ends of an amplifier may be connected by a switch to be initialized.

While a pixel output is changed to a voltage by a signal, a voltage of an input end of an amplifier may be changed by ΔV (=V_{R}−V_{S}). An output of the amplifier may be represented as (ΔV×amplification ratio). Herein, the amplification may be determined as C₁/C₂. For example, if Ci is 1 pF and if C₂ is 0.5 pF, the amplification may be 2.

FIG. 5D is a drawing illustrating a third phase φ₃ according to control of a switching unit and is a stage of short-circuiting between an amplifier and a capacitor C1 and sampling an output of the amplifier in the capacitor C1.

FIG. 5E is a drawing illustrating a fourth phase φ₄ according to control of a switching unit and is a stage for AD conversion. An output of an amplifier is inverted if a ramp voltage is more increased than a voltage of a minus (−) input of the amplifier by fixing a voltage sampled in the capacitor C1 (a third phase) at a minus (−) input of the amplifier and providing a ramp signal to a plus (+) input of the amplifier. A counter operates during a time when the ramp voltage is changed from a minimum to a maximum, and AD conversion may be accomplished by storing a value of the counter when an inversion signal is generated. For example, if using a counter of counting from 0 to 1023 during a time when the ramp voltage is changed from a minimum to a maximum, a pixel output having 10-bit resolution may be obtained.

In other words, the switches S8, S6, S5, S1, and S7 may be turned on in order in the first phase φ₁, and an illumination signal which is an input signal may be received. The switches S8, S6, S5, and S1 may be turned on in order in the second phase φ₂, and an illumination signal which is an input signal may be sensed. The switches S8, S6, S5, S3, and S4 may be turned on in order in the third phase φ₃, and a detected pixel output may be amplified. The switches S2, S5, and S9 may be turned on in order in the fourth phase φ₄, and AD conversion of the amplified pixel output may be performed.

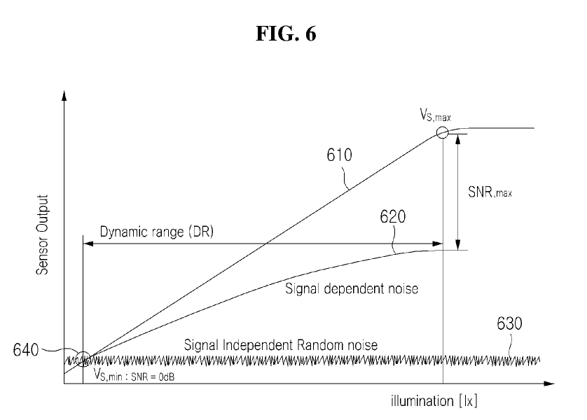

FIG. 6 is a drawing illustrating a change in an output of an image sensor according to a change in a pixel output according to an embodiment of the present disclosure.

Referring to FIG. 6, as illumination is more increased, it may be verified that an output 610 of an image sensor is more increased. A noise as well as a pixel output may be included in an input signal. The noise may be divided into a signal dependent noise 620 which is dependent on a pixel output and a signal independent random noise 630 which is independent of the pixel output. If an input signal is increased using a digital amplifier to enhance an output of an image sensor, since a noise is amplified together, it is difficult to enhance output efficiency of the image sensor. Thus, a bandwidth of a noise may be limited in a proposed method, and an analog amplifier for increasing only a pixel output may be used. As such, if a bandwidth of a noise is limited and if only a pixel output is increased, the image sensor may enhance a minimum illumination value 640 for detecting a pixel output. Thus, efficiency of the image sensor may be enhanced.

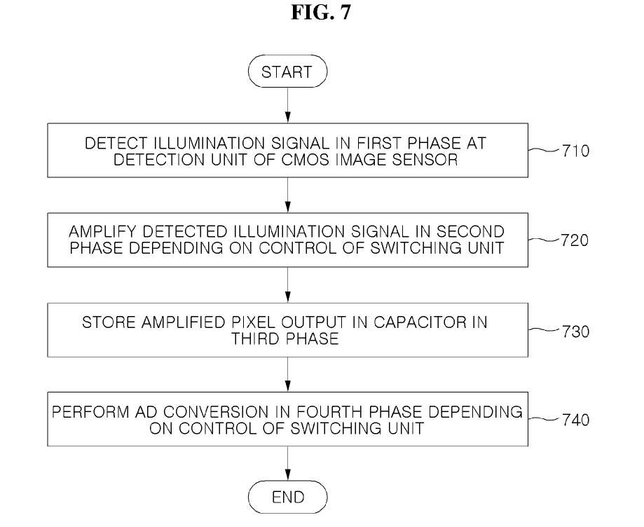

FIG. 7 is a flowchart illustrating a method for embodying an ADC and a PGA using a common amplifier according to an embodiment of the present disclosure.

The method for embodying the ADC and the PGA using the common amplifier may include detecting (710), by a detection unit of a CMOS image sensor, a pixel output depending on control of a switching unit, amplifying (720), by an amplification and conversion unit of the CMOS image sensor, the detected pixel output depending on control of the switching unit, storing (730), by the amplification and conversion unit, the amplified pixel output in a capacitor, and performing (740), by the amplification and conversion unit, AD conversion depending on control of the switching unit.

In operation 710, the detection unit of the CMOS image sensor may detect a pixel output depending on control of the switching unit. In this case, a noise signal may be included in the pixel output. A bandwidth of the noise signal may be limited in a pixel output input for effective image sensing, and a level of the pixel output should be amplified.

In operation 720, the amplification and conversion unit may amplify the detected pixel output depending on control of the switching unit. The amplifying of the detected pixel output in a second phase depending on control of the switching unit may include amplifying the detected pixel output using an analog amplified in the second phase. Further, the amplification and conversion unit may amplify a signal by an amplification ratio using an SC amplifier and may fail to amplify a noise of a high frequency component.

In operation 730, the amplification and conversion unit may store the amplified pixel output in a capacitor.

In operation 740, the amplification and conversion unit may perform AD conversion depending on control of the switching unit. In this case, the amplifying of the detected pixel output depending on the control of the switching unit and the performing of the AD conversion depending on the control of the switching unit may include performing the amplification and AD conversion of the pixel output using one amplifier depending on the control of the switching unit. Power consumption may be greatly reduced and a circuit area may be considerably reduced by performing the amplification and AD conversion of the pixel output using the one amplifier.

While a few exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other components or equivalents.

Therefore, other implements, other embodiments, and equivalents to claims are within the scope of the following claims.

1. An apparatus for embodying an analog-to-digital converter (ADC) and a programmable gain amplifier (PGA) using a common amplifier, the apparatus comprising:
a switching unit configured to perform a phase shift according to a switching operation;
a capacitor unit configured to include an input capacitor for playing a role as sample and hold (S/H) of a pixel signal and correlated double sampling (CDS) depending on control of the switching unit and a feedback capacitor for adjusting an amplification ratio; and
an operational amplifier configured to perform analog-to-digital (AD) conversion by playing a role as an amplifier and a comparator depending on control of the switching unit.

2. The apparatus of claim 1, wherein the operational amplifier comprises one amplifier and performs amplification and AD conversion of a pixel output using the one amplifier depending on control of the switching unit.

3. The apparatus of claim 1, wherein the operational amplifier amplifies a detected pixel output by a set amplification ratio using an analog amplifier.

4. The apparatus of claim 1, wherein the operational amplifier amplifies a signal by the amplification ratio using a switched-capacitor (SC) amplifier and does not amplify a noise of a high frequency component.

5. A method for embodying an ADC and a PGA using a common amplifier, the method comprising:
detecting, by a detection unit of a complementary metal-oxide semiconductor (CMOS) image sensor, a pixel output depending on control of a switching unit;
amplifying, by an amplification and conversion unit of the CMOS image sensor, the detected pixel output depending on control of the switching unit;
storing, by the amplification and conversion unit, the amplified pixel output in a capacitor; and
performing, by the amplification and conversion unit, AD conversion depending on control of the switching unit.

6. The method of claim 5, wherein the amplifying of the detected pixel output depending on the control of the switching unit and the performing of the AD conversion depending on the control of the switching unit comprises:
performing the amplification and AD conversion of the pixel output using one amplifier depending on the control of the switching unit.

7. The method of claim 5, wherein the amplification of the detected pixel output depending on the control of the switching unit comprises:
increasing a pixel signal in level by amplifying the detected pixel output at a controllable amplification ratio using an analog amplifier.

8. The method of claim 5, wherein the amplification of the detected pixel output depending on the control of the switching unit comprises:
amplifying a signal by an amplification ratio using an SC amplifier; and
not amplifying a noise of a high frequency component.
